(19) United States
(12) Patent Application Publication
(10) Pub. No.: US 2007/0156824 A1
(43) Pub. Date: Jul. 5, 2007

(54) Community messaging system

(75) Inventor: Arthur K. Thompson, Belfast (IE)

Correspondence Address: PETER J. VAN BERGEN, ESQ., 402 West Duke of Gloucester St., Williamsburg, VA, 23185, US

(73) Assignee: SWARMTEAMS LTD.

(21) Appl. No.: 11/404,154

(22) Filed: Apr. 14, 2006

(30) Foreign Application Priority Data
Jan. 5, 2006 (GB) 0602523.3

(51) Int. Cl. G06F 15/16

(52) U.S. Cl. 709/206

(57) ABSTRACT

A system for distributing electronic messages amongst a plurality of users wherein the system comprises a server and a plurality of client devices in communication by means of at least one communications network. A message management module maintains a message storage device, and provides a message user interface by which messages in the storage device can be displayed or accessed by said client devices. The users each belong to at least one of a plurality of user groups, and, upon receipt of an original message from a first user via a first client device in respect of a first user group, the message management module causes the message to be sent to client devices associated with other users belonging to said first group. Upon receipt of a reply message from at least one of said other users via a respective client device, the message management module causes the, or each, reply message to be displayed on said message user interface in association with said original message.

### FIELD OF THE INVENTION

The present invention relates to a system for distributing electronic messages amongst a community of users via one or more communications network or channels.

### BACKGROUND TO THE INVENTION

Modem communications technology, in particular, email and mobile (cellular) communications, has created an effective means of one-to-one communication between individuals. It is considered, however, that current technology does not provide an efficient means of group communication, particularly where the members of the group are distributed and mobile. It would be desirable, therefore, to provide an improved messaging system for group communications.

### SUMMARY OF THE INVENTION

Accordingly, a first aspect of the invention provides a system for distributing electronic messages amongst a plurality of users, the system comprising a server and a plurality of client devices in communication by means of at least one communications network, the server supporting a message management module arranged to maintain a message storage device, and to provide a message user interface by which messages in the storage device can be displayed or accessed by said client devices, wherein said users each belong to at least one of a plurality of user groups, and wherein, upon receipt of an original message from a first user via a first client device in respect of a first user group, the message management module causes the message to be sent to client devices associated with other users belonging to said first group, and wherein, upon receipt of a reply message from at least one of said other users via a respective client device, the message management module causes the, or each, reply message to be displayed on said message user interface in association with said original message.

Said at least one communications network may include a computer network, for example a LAN, WAN and/or the internet, and/or a telephone network, especially a mobile (cellular) telephone network. Hence, messages may be sent as web postings, emails, SMS messages, Instant Messages, datafeeds (e.g. Rich Site Summary, or Really Simple Syndication (RSS)) and/or any other conventional electronic messaging medium.

In preferred embodiments, each message may include, or be associated with, one or more tags, identifiers or indicators that are detectable by the message management module, the message management module being arranged to process a received message in accordance with the setting of the, or each tags, identifiers or indicators. For example, each client device may be associated with a range and original messages may include, or be associated with, a range identifier, the message management module being arranged to send said original messages only to client devices whose range is compatible with said range identifier.

Preferably, the message management module maintains a profile database, or other storage device, containing respective profile information for each client device, said profile information including contact details.

A second aspect of the invention provides a message management module for use in a system for distributing electronic messages amongst a plurality of users, the system comprising a server and a plurality of client devices in communication by means of at least one communications network, the message management module being arranged to maintain a message storage device, and to provide a message user interface by which messages in the storage device can be displayed or accessed by said client devices, wherein said users each belong to at least one of a plurality of user groups, and wherein, upon receipt of an original message from a first user via a first client device in respect of a first user group, the message management module causes the message to be sent to client devices associated with other users belonging to said first group, and wherein, upon receipt of a reply message from at least one of said other users via a respective client device, the message management module causes the, or each, reply message to be displayed on said message user interface in association with said original message.

A third aspect of the invention provides a method for distributing electronic messages amongst a plurality of users in a system comprising a server and a plurality of client devices in communication by means of at least one communications network, the method comprising maintaining a message storage device; and providing a message user interface by which messages in the storage device can be displayed or accessed by said client devices, wherein said users each belong to at least one of a plurality of user groups, the method further including, upon receipt of an original message from a first user via a first client device in respect of a first user group, causing the message to be sent to client devices associated with other users belonging to said first group; and, upon receipt of a reply message from at least one of said other users via a respective client device, causing the, or each, reply message to be displayed on said message user interface in association with said original message.

A fourth aspect of the invention provides a computer program product comprising computer program code for causing a computer to perform the method of the third aspect of the invention.

Other preferred features of the invention are recited in the dependent claims.

Further advantageous aspects of the invention will become apparent to those ordinarily skilled in the art upon review of the following description of a preferred embodiment of the invention and with reference to the accompanying drawings.

### BRIEF DESCRIPTION OF THE DRAWINGS

An embodiment of the invention is now described by way of example and with reference to the accompanying drawings in which:

FIG. 1 is a schematic view of a communications system in which a messaging system embodying one aspect of the invention may be implemented;

FIG. 2 is a schematic view of a messaging system embodying one aspect of the invention;

FIG. 3 is an example of a message board; and

FIG. 4 is an example of a suitable SMS record layout including examples of suitable message tags.

### DETAILED DESCRIPTION OF THE DRAWINGS

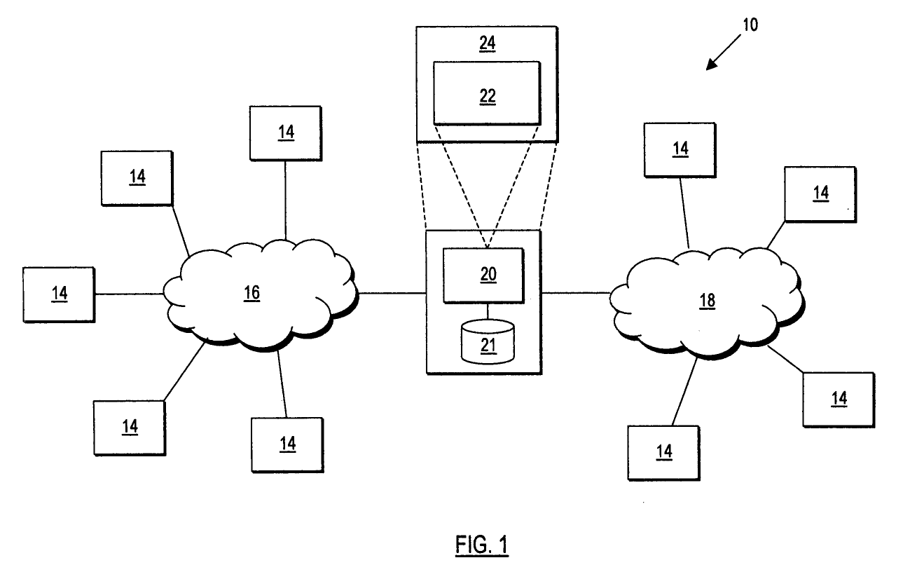

Referring now to FIG. 1 of the drawings, there is shown, generally indicated as 10, a communications system comprising a server device 12 and a plurality of client devices 14. The server 12 and clients 14 may communicate via at least one communications network including, in the preferred embodiment, a telephone network 16 and a computer network 18. The telephone network 16 advantageously comprises a mobile (cellular) telephone network but may also include a standard telephone network, e.g. a public switched telephone network (PSTN). The computer network 18 advantageously comprises the Internet or other global computer network.

The server 12 conveniently takes the form of a computer, or other data processing device, supporting at least one server application (and possibly one or more client applications) as will be apparent to the skilled person upon review of the act as a web server, an email server and an SMS (short messaging system) server and so supports corresponding server applications. In alternative embodiments, the server 12 may act as one or more of a web server, an email server or an SMS server. More particularly, the server 12 supports a message management module 20 by which electronic messages may be communicated amongst the clients 14 as is described in more detail below. The module 20 maintains a message database or other message storage device 21. The message management module 20 provides a message user interface or display 22 (hereinafter referred to as the message board 22) by which messages in the database 21 can be displayed or accessed. In the preferred embodiment, the server 12 provides a website 24 by which the message board 22 may be accessed or viewed by at least some of the clients 14.

The clients 14 may each comprise any suitable computer or data processing device, including static devices, such as personal computers (PCs), and mobile computing devices such as mobile (cellular) telephones, PDAs (personal digital assistants) or laptop computers. Each client 14 is able to communication with the server 12 by at least one of said networks 16, 18. To this end, in the present embodiment, each client 14 may support applications to enable it to act as a web client, an email client and/or an SMS client.

The message management module 20 may comprise a plurality of computer programs for performing various tasks described hereinafter, as will be apparent to the skilled person. Conveniently, the module 20 includes a message board application, for supporting and maintaining the message board 22, which is similar to conventional message board applications except that it is modified to perform aspects of the invention as-described below. In typical embodiments, the system 10 supports more than one groups of users in which case it is preferred that the module 20 provides a respective message board 22 for each group.

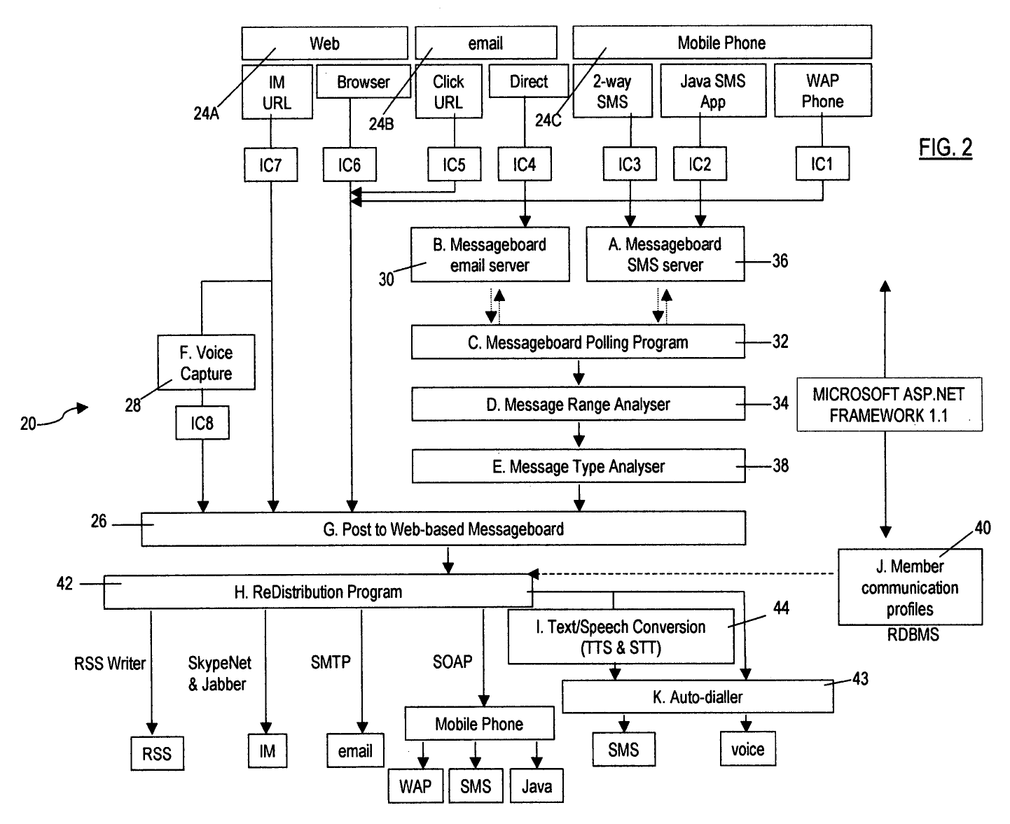

Referring now in particular to FIG. 2, the message management module 20 is described in more detail. Incoming messages 24 may be received from the clients 14 via the networks 16, 18 in any convenient medium. By way of example, in FIG. 2, message 24A is a web message or posting (e.g. from a web browser supported by, for example, one of the client devices 14, or by means of Instant Message (IM) received from a client 14 via the website 24), message 24B is an email (which may for example be sent directly or by selecting an embedded internet link in the email) and message 24C is a mobile device (e.g. mobile telephone) originated message, for example via standard SMS or via a customised SMS generated by a Java or similar application running on the handset of a mobile device, or via a WAP Internet message sent from a web enabled handset. In the example illustrated in FIG. 2, this provides 7 incoming channels (labelled IC1 to IC7). An eighth incoming channel IC8 is described below.

Advantageously, each message 24 is associated with a message thread identifier (messageID) for identifying to which thread of messages the respective message belongs. For example, the messageID may be included in the body or text of the message, or in the header of the message (if the message is an email). When a message 24 is received by the message module 20, the module 20 checks if the message 24 is associated with a messageID. If so, then the module 20 associates the received message 24 with any other received messages associated with the same messageID. If not, then the module 20 assigns a new messageID to the received message 24.

The module 20 includes a posting module 26 which causes received messages 24 to be stored in the database 21 for display on the message board 22. In the preferred embodiment, the posting module 20 checks the messageID of each received message and causes messages with the same messageID to be displayed on the message board 22 in association with one another. Preferably, messages having the same messageID are displayed adjacent one another physically on the message board 22. Messages that are assigned a new messageID for the first time are considered to be original messages and are preferably displayed first or foremost with respect to other messages having the same messageID. Messages that are already associated with a messageID when received by the module 20 are considered to be replies to the original message. Reply messages are preferably displayed on the message board 22 in a manner that is subsidiary to the original message having the same messageID. For example, the reply messages could be displayed on the message board 22 physically below or beside the associated original message. Alternatively, the reply messages may be linked to the respective original message such that they are displayed whenever a user selects the original message via the message board 22. The reply messages themselves may be ordered or arranged with respect to one another in any convenient manner.

For example, the reply messages may be displayed in the order that they are received.

Web messages 24A, especially those comprising a text message, may be processed by said posting module 26 directly. The message management module 20 may include an audio recording module 28 allowing, for example, a user, via a client 14, to submit a voice message. The audio recording module 28 may for example comprise a voice or speech encoder for storing the audio message in a convenient electronic format, e.g. MP3. Messages, e.g. web messages 24A, comprising an audio message (typically speech) may therefore be forwarded to the posting module 26 via the audio conversion module 28, i.e. after conversion to a suitable electronic format. This provides the eighth incoming channel IC8. In alternative embodiments, audio messages may be received through any other convenient medium, e.g. as an email attachment or voice mail. In some embodiments, the mobile telephone number from a voice message may be used to identify the sender of the message and an associated default group to which he belongs and/or as a messageID, such that any replies may be posted on an appropriate message board.

In the preferred embodiment, the message management module 20 includes, or is co-operable with, an email server 30 for receiving email messages 24B. The email server 30 supports at least one and, in a simple embodiment, a single email address for receiving email messages 24B. The email server 30 may receive and store email messages in conventional manner.

In embodiments where messages may be received in SMS, or similar, format, at least some of the received SMS or text messages 24C may be redirected to the email server 30, e.g. to said single email address, by a redirect facility. The redirect facility may conveniently be provided by the SMS service provider or network operator. At least reply messages may also be redirected to the email server 30. In a preferred embodiment, the SMS service is arranged to notify the module 20 with an Instant Message (or similar communication) with the SMS details, in which case it is not necessary to re-direct SMS messages via the email server 30. To this end, the module 20 may include or be associated with an SMS server 36.

Preferably, the module 20 also includes a polling program or module 32 co-operable with the email server 30 and SMS server 36 to detect received email messages 24B (including redirected SMS messages 24C) and messages emanating directly from mobile devices, and to cause received messages to be forwarded to a message parsing module 34. The polling module 32 may, for example, check for new messages at the servers 30, 36 periodically, e.g. at intervals of 10-30 seconds.

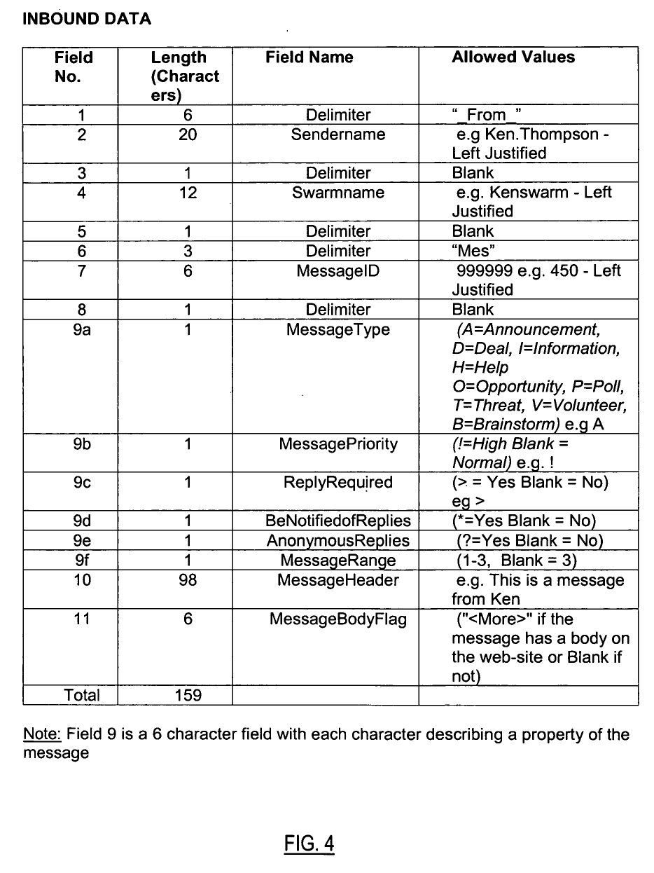

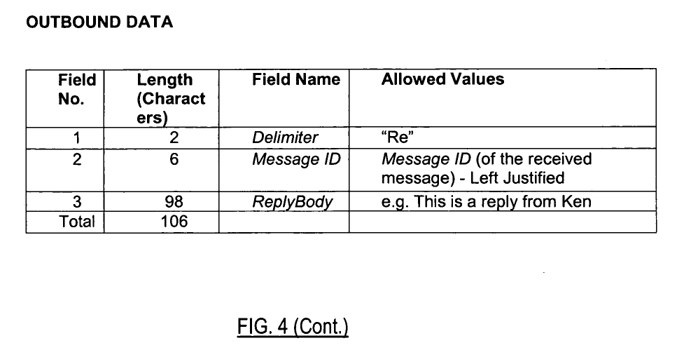

The parsing module 34 parses the body or text of the messages, and/or the header if the message, e.g. email, has a header, to extract one or more tags or identifiers from the message. The tags/identifiers may include some or all of the following: messageID; a sender identifier (senderID); at least one group identifier (groupID); a broadcast indicator (broadcastID); reply notification requirements indicator (reply_notID); and an outbound message formats indicator (formatID). Tags/identifiers/indicators may be included in, or associated with, a message in any convenient manner. For example, an incoming, or outgoing, message may include one or more characters serving as one or more delimiters and/or one or more characters serving as one or more indicators. The parser 34 detects valid delimiters and extracts the, or each, character following a delimiter, or between pairs of delimiters. Other characters may be used to convey specific meanings in a shortened manner. FIG. 4 gives examples of suitable tags/identifiers. It is noted that the “blank” character may be used to denote specific (usually default) meanings. The position/location of the characters in the message determines the significance of the data conveyed by the characters (or located after or between the characters in the case of delimiters). In some cases (e.g. where messages are sent by web, email or custom application on the mobile device) the tags/indicators may be inserted automatically by the respective software. In other cases (e.g. simple SMS messaging) the user can insert the relevant indicators when creating the message. In the absence of any required indicators, the module 20 may employ a suitable default.

An analysing module 38 may also be provided for analysing the header portion of email messages or other messages having headers. The analysing process, which may conveniently be performed by parsing, extracts one or more tags or identifiers from the message header. The tags/identifiers may include one or more of the following: a message type identifier (typeID); an urgency indicator (urgencyID); a reply required indicator (reply_reqID); and an anonymity flag. It will be understood that these identifiers may alternatively be provided in the message body and so detected by the parsing module 34. Similarly, the identifiers described above in connection with the parsing module 34 may alternatively be provided in the header and so detected by the module 38. Moreover, the analysing module 38 and parsing module 34 may be considered as, or replaced by, a single module for performing the relevant parsing/analysing tasks.

The parsed and analysed messages, or at least the message portion of same, are then passed to the posting module 26 for storage in the database 21, in association with any respective tags, indicators or identifiers that were extracted by modules 34 and 38, and displayed on the message board 22 in a manner the same or similar to that described above for the web messages 24A. Typically, the parsing module 34 (or analysing module 38) also extracts the messageID of messages received by it and makes this information available to the posting module 26.

The system 10 is particularly suitable for use by one or more groups of users, each group comprising a plurality of users, typically individuals. Each member of a group is associated with a group identifier (groupID). A user may belong to more than one group and so may be associated with more than one groupID. The system 10 includes a database 40, or other storage device, for storing information including contact details concerning each member of the, or each, group supported by the system 10. Typically, the stored information is profile information including the user's name, at least one contact address/number (typically an email address and/or a mobile telephone number) and at least one groupID. The database 40 may store additional information for each user, as will be described in more detail below. For example, an availability indicator may be supported, the setting of which (typically by the user) allows the user to dictate whether or not he will receive messages.

In a preferred embodiment, one user of each group is designated as the group originator, or owner. The group originator creates a group by registering the group at the website 24 whereupon it is assigned a groupID. The group originator then sends an invitation message to each other intended member of the group (e.g. by web message, email or SMS) inviting them to register with the group (and providing, for example, a password allowing them to register with the respective group. Each invited member then registers with the group (conveniently via the website 24). Registration typically involves providing said profile information to the module 20 for storage in the database 40. Once the registration process is complete, messages may be communicated amongst members of the group, for example, by SMS, email or web message as is described in more detail below.

In the preferred embodiment, there are two main forms of message: an original message; and a reply message, the reply message comprising a reply to an original message. Each member of a group is able to send original messages and reply messages. Original messages are advantageously broadcast to all available members of the group to which the message originator (i.e. the group member sending the original message) belongs. In cases where the message originator belongs to more than one group, the original message may be sent to all available members of each group to which he belongs (but preferably not back to the originator of the message), or only to all available members of one or more selected groups to which he belongs. Preferably, the message originator is able to select said one or more groups. In a preferred embodiment, each user is associated with a default group (which, for example, may be determined from the mobile phone number, email address, senderID or other unique identifier associated with the received message) and, if the user does not specify a group when sending a message, then the module 20 directs the message to the user's default group. In the preferred embodiment, the module 20 determines to which group(s) a message is directed by the groupID(s) included in or associated with the message and, only if there is no groupID with the message, uses the default group.

Each group member may advantageously select whether or not to receive original messages that are broadcast to the group. This may for example be achieved by means of the availability indicator described above. For example, in one embodiment, a user may set his chosen respective availability/communication preferences for each group that he belongs to by toggling on or off one or more of a plurality of preference indicators for each group. These indicators may include a respective indicator for indicating whether or not the user is accepting messages by email, SMS, Instant Message and/or RSS. The module 20, and more particularly the distribution program 42, may access this information (e.g. from the profile database 40). User interaction with the system 10 including creating a group, registering with a group, setting preference indicators or providing any other information to the system may conveniently be performed by one or more suitable user interfaces (not illustrated) which may be made available at the web site 24, e.g. by module 20 or by another application supported by the server 12.

Referring again to FIG. 2, when a message is posted to the database 21 and is not associated with a messageID, the module 20 determines that the message is an original message and so takes steps to broadcast the message to the other members of the group(s) to which the message originator belongs. In the following illustration, it is assumed that the message originator belongs to a single group. A message distribution program 42 is co-operable with the message database 21 and the profile database 40. The distribution program 42 determines to which group(s) the originator of the original message belongs. The distribution program 42 then checks the profile database 40 to identify the other members of the respective group. In one embodiment, the distribution causes the original message to be broadcast to all members of the group. In the preferred embodiment, the distribution program 42 causes the message to be sent only to available members of the group as determined by, for example, the setting of the respective availability indictor for each group member. Alternatively, or in addition, the distribution program 42 may cause original messages to be sent only to those members of the group who have contacted, via their respective client 14, the module 20 indicating that they are available to receive messages.

The original message is sent to the group members by one or more communication medium, e.g. web message and/or email and/or SMS or text message and/or voice message, as applicable to each group member. Details for contacting each group member is stored in the profile database 42. The original message may be sent to each group member by all communications media associated with the respective group member. Alternatively, each group member may specify, from time to time, a preferred or designated medium for receiving messages. This can be achieved, for example, by means of the preference indicators described above.

In order to send messages to the group members, the module 20 preferably includes or is co-operable with an email server (conveniently the email server 30) supporting, for example SMTP (Simple Mail Transfer Protocol); and/or means for sending SMS/text messages (e.g. supporting SOAP (Simple Object Access Protocol); and/or means for sending Instant Messages (e.g. supporting SkypeNet and/or Jabber); and/or means for sending RSS messages. The module 20 may also include, or be co-operable with, means for sending voice messages to group members including, for example, an auto-dialler 43 for auto-dialling the respective telephone numbers of any group member who is to be contacted via telephone, or any other similar device (client 14). A text-to-speech (TTS) and/or speech-to-text (STT) conversion module 44 for converting a text based original message into a synthesised voice message (e.g. in MP3 format) and/or vice versa, may be provided and used by the distribution program 42 if required. Alternatively still, the original message may take the form of a voice message which may be sent to one or more of the group members, as applicable, via the auto-dialler 43. The auto-dialler 43 may be configured to play a voice message to the group member if the group member answers his client device 14, or to leave a message if the group member does not answer. Alternatively, or in addition, the auto-dialler 43 may be configured to re-dial if a message is not delivered. In the illustrated example, the foregoing provide eight outbound channels.

Original messages, when broadcast to the group members, include, or are associated with a respective messageID. Conveniently, the posting module 26 assigns a messageID to each original message. In the case where the outgoing message is being sent by email, it is preferred that the messageID is included in the email header. Alternatively, the message ID may be included in the body of the message as additional text, or voice message, as applicable.

The original message is rendered to the group members by their respective client 14. Each group member may send a reply to the original message by any supported communications medium. Each reply message includes, or is associated with, the messageID of the original message. When the received original message is an email that includes the messageID in the header, this is readily achieved by sending a reply email message. In other cases, the user may add the messageID into the body of the reply message. Reply messages are received by the module 20 and are processed as described above.

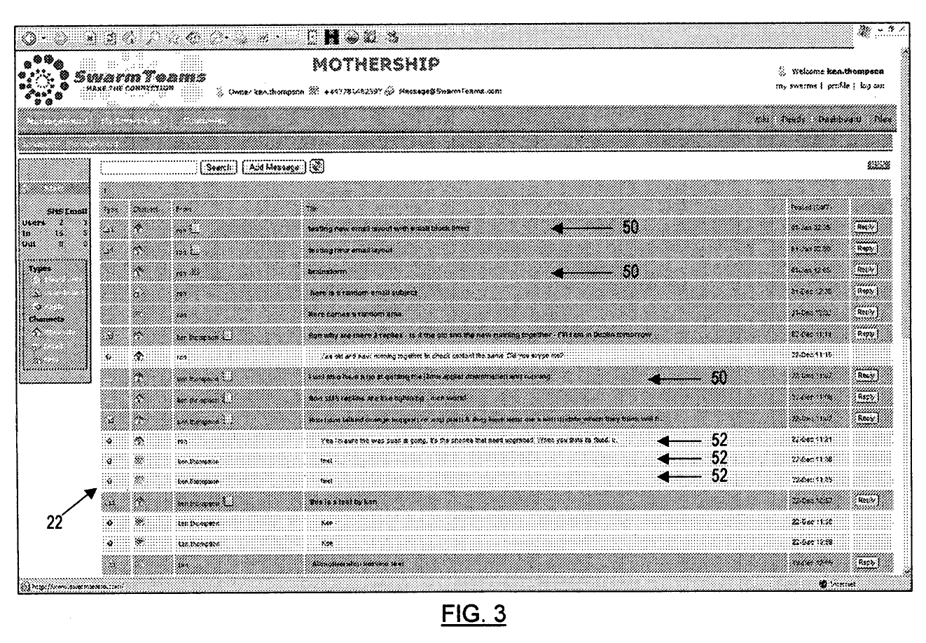

FIG. 3 shows an example of a message board 22 for a group. In FIG. 3, the term “swarm” is used in place of “group”. The message board 22 displays original messages 50 relating to the group and also displays any respective reply messages 52 in physical association with the respective original message. An original message and/or a reply message may be associated with more than one group and so may appear in the message board 22 for more than one group. In some cases, a reply message does not need to include a specific groupID since the messageID ensures that the reply reaches the correct message board. Preferably, replies to messages that are sent to more than one group are sent to the originating group only.

As a result, each group member is able to see, via the message board 22 for the group, all of the messages relating to that group, including all original messages and all replies.

Optionally, at least some of group members may elect to have the reply messages sent to them, i.e. to one or more of their respective client devices 14. In particular, in the preferred embodiment, the message originator may elect to have all replies to his original message sent to him via email, SMS or other supported communications medium. If the message originator creates the original message as a web message directly at the website 24, then this may be achieved by, for example, selecting an option provided by the GUI (not shown). Alternatively, if the original message takes the form of an email or SMS message, then the message originator may include or associate a tag, indicator or identifier (e.g. the reply_notID mentioned above) in or with the original message (e.g. in the header or in the message body).

In the preferred embodiment, original messages and/or reply messages may be designated as being of one or more of a plurality of message types. To this end, a message may include, or be associated with, one or more type identifiers (typeID) ach message type provides an indication of the contents of the message, or, more particularly, the meaning of the contents of the message. Preferred embodiments support at least some of the following message types: Announcement, i.e. the message contains an announcement; Opportunity, i.e. the message contains information relating to an opportunity; Threat, i.e. the message contains information relating to a threat; Information, i.e. the message contains neutral information; Poll, i.e. the message contains a request for opinions; Deal, i.e. the message contains information concerning a transaction, e.g. buying or selling; Help, i.e. the message contains a request for help; Volunteer, i.e. the message contains an offer to help others.

Advantageously, when a message is displayed on the message board 22, one or more applicable icons or other indicators are displayed or associated with the message on the message board 22 indicating the type(s) of the message. This arrangement helps members of the group to assimilate the message board 22 more easily.

In preferred embodiments, a plurality of message distribution ranges are defined.

A message originator may select a distribution range to which an original message is sent. Each member of the group may select to be associated with a desired distribution range such that they are only sent messages having a compatible distribution range. Preferably, the distribution ranges overlap such that each successive range includes the preceding range(s). Assuming, for example, that there are three distribution ranges (although in practice there may be two or more distribution ranges), then messages designated as range 1 are only sent to group members who have associated themselves with range 1, messages designated as range 2 are sent to group members who have associated themselves with range 1 or range 2, and messages designated as range 3 are sent to group members who have associated themselves with ranges 1, 2 or 3. To this end, when the message originator creates an original message, he may associate with it a range or broadcast indicator (broadcastID) designating the required broadcast range. Upon detection of a broadcastID, the module 20, or more particularly the distribution program 42 in the preferred embodiment, causes the message to be sent to any group member associated with a range that matches, or is within, the range specified by the broadcastID.

It is noted that, in the preferred embodiment, the range facility described above does not affect reply messages—it is only an attribute of original messages. All replies are posted to the message board 22 as before. It is also noted that all group members, irrespective of their associated range, are able to view all messages on the message board 22 irrespective of the range of the message.

Preferred embodiments may also support communication of messages amongst groups. An example of preferred inter-group communication is now described.

A first group originator, or group “owner”, can always send a directed message to the owner of a second group provided they know the groupID of the second group and the second group is accepting messages from other groups (this may be set using a preference indicator). The owner of the second group, upon receiving a message from the first group, decides whether he wishes to reply and/or to circulate the received message to the members of the second group. It is preferred that only the owner or originator of a group is able to sent messages to another group.

Advantageously, two types of inter-group connections are provided for, referred to hereinafter as “Links” and “Overlaps”. It is preferred that Links and Overlaps can only be created by group owners. A Link is a deliberate direct relationship established by the respective owners of two groups. It can either be: a “Bond”, which is a strong relationship causing an automatic distribution of messages from the sending group to all members of the receiving group; or a “Bridge”, which is similar to a Bond but is a medium relationship where the message distribution amongst the members of the receiving group is at the discretion of the owner of the receiving group.

Links are preferably created by one of the group owners and are, by default, a one way communication link, i.e. a link that allows messages to be sent from a first group to a second group does not necessarily allow messages to be sent from the second group to the first group. However, the owner of the second group can elect to make the link a 2-way link. Further, between two groups there could be a Bond in one direction and a Bridge in the other.

Links may be effected in any convenient manner. For example, the database 21 may include, or be associated with, a links table (not shown) with a respective record to indicate a link between two (or more) groups. Each record may contain an identifier for each group and at least two data fields, a first indicating the type of link going from a first group (group1) to a second group (group2) (Bridge or Bond), a second indicating the type of link going from group2 to group1 (Bridge or Bond). This allows for groups to be linked in only one direction if required—e.g. a one-way unidirectional link from a parent group to a child group.

An Overlap is a commonality of members between two (or more) groups which may produce some mutual benefit—it is an informal relationship with no formal links. Overlaps exist when a member of one group is also the owner of another, and/or when an owner owns more than one group. The case where a member of a group is only a member (as opposed to being the owner) of another group is preferably excluded from being an overlap. This is because it would violate the preferred principle that only owners act as the “gatekeepers” of access between groups. Overlaps provide for social/business networking via messages such as “does anybody know . . . ”, which can be propagated through an informal network of overlaps, with permission from each group owner, and without the sender knowing exactly who they will go to.

A first group owner can grant access to a second group owner to allow the second group owner to transmit messages to the first group and so all links are created 1-way into the receiving group. To make the link 2-way, the second group owner can reciprocate by granting access to the second group. In the preferred embodiment, no computer dialog is required between group owners to create links. Links are advantageously created and edited via the website 24. For example, a web page (not shown) providing a user interface (referred to hereinafter as the Manage Links Screen) may be provided. In a typical embodiment, the Manage Links screen allows a group owner to select a first group for receiving inter-group messages, a second group that is allowed to send messages to the first group and whether the link is to be a Bond or a Bridge.

In the preferred embodiment, the owner of the receiving group (i.e. the group on the receiving end of a link) effectively becomes a member of the other group and his contact details are as such available to the distribution program 42. In one embodiment, all original messages for the other group are distributed to the owner of the receiving group as if he was a member of the other group. In an alternative embodiment, the distributionID, or other tag or indicator, may be used to indicate that a message is to be sent to the owner of the receiving group. For example, in cases where the range facility is supported, a range may be defined that includes one or more other groups such that, when the distributionID is set to said range, the message is sent to any linked group(s), or to the owner of one or more linked group, whereupon it may automatically (e.g. in the case of a Bond), or at the discretion of the group owner (e.g. in the case of a Bridge), be distributed amongst the members of the linked group(s). This range preferably embraces, or overlaps with, the other defined ranges such that any messages sent to a linked group are also sent to all other ranges (e.g. in the 3-range example provided above, a fourth range may be provided beyond range 3 for this purpose). Any replies made by the receiving group owner (or by any member of his group) are posted on the message board 22 of the other group (or of both groups). Moreover, a respective setting of the distributionID, or other tag or indicator, e.g. a respective range, may be defined for bond links and for bridge links. So, for example, range 4 may cause message to be sent to group owners with which there is a Bond, while range 5 may cause messages to be sent to group owners with which there is a Bridge. Links are preferably made between two groups only, although each group can establish a link with any number of other groups. In preferred embodiments, inter-group messages that are passed between linked groups can only be sent by respective group owners. More preferably, inter-group messages can only be initiated via the web site 24 (e.g. by web message) or by web enabled mobile devices.

As described above, a Bond is a single directional link between two groups which allows the automatic flow of messages from one group to (the members of) the other. Bonds are the mechanism for creating “sub-groups” via 1-way bonds from a parent group to a child group and “group-partnerships” via 2-way bonds. For example, assume that a first group G1 has a sub-group G2, then all directed messages, or those designating the relevant range (e.g. range 4), sent from the owner of, or one or more authorised members of, G1 are automatically distributed to all members of G2 (and, optionally, any of G2's sub groups). In a further example, assume that G1 is in a group partnership with a third group G3, then any messages having the relevant range (e.g. range 4) sent by either the owner of, or one or more authorised members of G1 or G3 are automatically distributed to all members of the other group. Preferably, inter-group messages (e.g. messages with ranges 4 or 5 in the present example) are sent only to one or more members of the other group (i.e. not to members of the sender's home group). Hence, inter-group ranges preferably do not embrace the intra-group ranges (e.g. ranges 1 to 3 in the present example). Optionally, however, inter-group messages may be sent to the owner of the home group.

As indicated above, a Bridge is a single directional link between two groups which allows the flow of messages from one group to (the members of) the other group at the discretion of the receiving group owner. Bridges are a mechanism for informal relationships between groups and the resulting communication of messages can be unidirectional or bi-directional. For example, assume that group G2 is linked to G2 unidirectionally by a Bridge. All directed messages, or those having the relevant range (e.g. range 5) sent from the owner of, or one or more authorised members of, G2 are automatically distributed to the owner of G1 who decides whether or not to distribute the messages to the members of G1. This process may be repeated for any further bridged groups.

In the preferred embodiment, the receiving group owners details are added into any inter-group distributed messages (so that recipients can tell where the message originated from) and all replies go back directly to all group owners associated with the message (e.g. using groupID and messageID).

Preferably, the module 20 ensures non-duplication of messages where a recipient is entitled to receive a message via multiple bridges or bonds (direct and indirect).

The invention is not limited to the embodiments described herein which may be modified or varied without departing from the scope of the invention.

1. A system for distributing electronic messages amongst a plurality of users, the system comprising a server and a plurality of client devices in communication by means of at least one communications network, the server supporting a message management module arranged to maintain a message storage device, and to provide a message user interface by which messages in the storage device can be displayed or accessed by said client devices, wherein said users each belong to at least one of a plurality of user groups, and wherein, upon receipt of an original message from a first user via a first client device in respect of a first user group, the message management module causes the message to be sent to client devices associated with other users belonging to said first group, and wherein, upon receipt of a reply message from at least one of said other users via a respective client device, the message management module causes the, or each, reply message to be displayed on said message user interface in association with said original message.

2. A system as claimed in claim 1, wherein each message is associated with at least one group identifier.

3. A system as claimed in claim 1, wherein said module is arranged to determine a default group for a message by detecting a unique identifier associated with the client device from which said message emanates.

4. A system as claimed in claim 1, wherein said at least one communications network includes a computer network and a cellular telephone network and wherein said messages may take at least one of the following forms: web postings, emails, SMS messages, Instant Messages and/or datafeeds.

5. A system as claimed in claim 1, wherein said module is arranged to cause the, or each, reply message to be displayed adjacent the respective original message.

6. A system as claimed in claim 1, wherein said module is arranged to cause the, or each, reply message to be associated with the respective original message by means of an activatable electronic link, the, or each, reply message being displayed upon activation of said electronic link by a user.

7. A system as claimed in claim 1, wherein each message includes at least one identifier that is detectable by the message management module, the message management module being arranged to process a received message in accordance with the setting of the, or each, identifier.

8. A system as claimed in claim 1, wherein each user is associated with any one of a plurality of ranges, and at least some of said original messages are associated with a range identifier, the message management module being arranged to cause said original messages to be sent only to users whose range is compatible with said range identifier.

9. A system as claimed in claim 8, wherein at least one of said ranges is defined to embrace at least one other of said ranges, the message management module being arranged to cause said original messages to be sent to users whose range matches the range associated with the respective original message and to users whose range is embraced by the range associated with the respective original message.

10. A system as claimed in Clam 1, wherein the message management module maintains a profile storage device containing respective profile information for each user, the message management module being arranged to determine to which users a received original message is to be sent by examining said profile information.

11. A system as claimed in claim 10, wherein the respective profile information includes an availability indicator, the message management module being arranged to cause messages to be sent to the respective user only if the respective availability indicator indicates that said user is available to receive messages.

12. A system as claimed in claim 10, wherein the respective profile information includes a reply notification requirements indicator, the message management module being arranged to cause reply messages to an original message to be forwarded to at least one client device associated with the user who sent said original message depending on the setting of the reply notification requirements indicator.

13. A system as claimed in claim 1, further including means for linking a first user group with a second user group so that at least some messages emanating from said first user group may be sent to at least one member of said second user group.

14. A system as claimed in claim 13, wherein a respective one user in each user group is designated as group owner, and wherein the message management module is arranged to allow only the group owner of said first group to cause messages to be sent to said second user group.

15. A system as claimed in claim 13, wherein a respective one user in each user group is designated as group owner, and wherein the message management module is arranged to allow only the group owner of said second group to receive messages sent from said first user group.

16. A system as claimed in claim 13, wherein an inter-group range identifier is associated with each message that is to be sent from said first group to said second group, the message management module being arranged to send a message from said first group to said second group upon detection of said inter-group range identifier in said message.

17. A system as claimed in claim 1, wherein at least some original messages are associated with a type indicator which indicates the nature of the message, the message management module being arranged to detect said type indicator and to display said original message on said message user interface in association with an indicator corresponding to said detected type indicator.

18. A message management module for use in a system for distributing electronic messages amongst a plurality of users, the system comprising a server and a plurality of client devices in communication by means of at least one communications network, the message management module being arranged to maintain a message storage device, and to provide a message user interface by which messages in the storage device can be displayed or accessed by said client devices, wherein said users each belong to at least one of a plurality of user groups, and wherein, upon receipt of an original message from a first user via a first client device in respect of a first user group, the message management module causes the message to be sent to client devices associated with other users belonging to said first group, and wherein, upon receipt of a reply message from at least one of said other users via a respective client device, the message management module causes the, or each, reply message to be displayed on said message user interface in association with said original message.

19. A method for distributing electronic messages amongst a plurality of users in a system comprising a server and a plurality of client devices in communication by means of at least one communications network, the method comprising maintaining a message storage device; and providing a message user interface by which messages in the storage device can be displayed or accessed by said client devices, wherein said users each belong to at least one of a plurality of user groups, the method further including, upon receipt of an original message from a first user via a first client device in respect of a first user group, causing the message to be sent to client devices associated with other users belonging to said first group; and, upon receipt of a reply message from at least one of said other users via a respective client device, causing the, or each, reply message to be displayed on said message user interface in association with said original message.
